(19) United States
(12) Patent Application Publication
(10) Pub. No.: US 2011/0252150 A1
(43) Pub. Date: Oct. 13, 2011

(54) System and Method for Processing User Information

(75) Inventors: Jyotibasu Chandrabasu, Austin, TX (US); Andrew Keys, Albany, OR (US); Eric W. Miller, Issaquah, WA (US)

(73) Assignee: BANK OF AMERICA CORPORATION, Charlotte, NC (US)

(21) Appl. No.: 12/757,472

(22) Filed: Apr. 9, 2010

(51) Int. Cl. G06F 15/16

(52) U.S. Cl. 709/228

(57) ABSTRACT

A method for processing information, such as user preferences and other user information, operates in connection with a server and/or a browser device. A connection is established between the browser device and the server, and a unique identifier is transmitted from the server to the browser device for storage on the browser device. User information is then received at the server, from the browser device and stored in a memory of the server, and the unique identifier is associated with the user information in the memory of the server. The user information includes one or more of the following types of information: language preferences, graphic display configuration preferences, other display preferences, disability preferences, marketing preferences, content preferences, personal user information, browsing history information, visitor type information, customer status information, relationship information, and user analytic information.

### TECHNICAL FIELD

The invention relates to a system and method for storing and loading user information, and more specifically, to a system and method for storing and loading user preferences.

### BACKGROUND

Many web servers and other such devices are configured for keeping track of the preferences of users who access the web server, such as users who access a website hosted or supported by the web server. Typically, such user preferences are tracked by placing information on the device operating the web browser, such as small pieces of text or code known as “cookies,” which can then be sent back from the browser to the web server upon subsequent connections to alert the web server to the user's preferences. However, the traditional use of cookies presents some drawbacks. For example, restrictions on the size and/or number of cookies accepted on a device can limit the tracking of user preferences. This concern may apply particularly on mobile devices, which may have smaller amounts of storage memory. Other such drawbacks are recognized by those skilled in the art.

Financial institutions have used so-called “server-side” cookies since 2004 or earlier. Such server-side cookies are stored on the server, rather than the user's computer, and are referenced to a persistent cookie on the user's computer that contains a unique identifier, such as a session ID. However, these existing uses of cookies present certain drawbacks and disadvantages which are not met by current technology.

### BRIEF SUMMARY

The present system and method are provided to solve the problems discussed above and other problems, and to provide advantages and aspects not provided by prior systems and methods of this type.

Aspects of the present invention relate to a method for processing information, such as user preferences and other user information, which operates in connection with a server. A connection is established with a browser device, at the server, and a unique identifier is transmitted from the server to the browser device for storage on the browser device. User information is then received at the server, from the browser device and stored in a memory of the server, and the unique identifier is associated with the user information in the memory of the server. The user information includes one or more of the following types of information: language preferences, graphic display configuration preferences, other display preferences, disability preferences, marketing preferences, content preferences, personal user information (including login or other authentication information, identification information, contact information, or other types of personal information), browsing history (including pages visited and the last page visited), visitor type (registered or unregistered by the web server), customer status (i.e. whether the user is a customer of an entity operating the web server or the web page), relationship information, and user analytic information. Additional user information is also received and stored, including analytic information derived from analysis of the existing user information. The additional user information is also associated with the user information in the server memory.

According to one aspect, the unique identifier is contained or stored within a cookie, which may include one or more name-value pairs. The cookie may be a persistent cookie and may have an expiration date.

According to another aspect, the unique identifier and the user information are associated with a first user of the browser device. In this embodiment, the method may further include establishing a second connection with the browser device, at the server, involving a second user of the browser device. A second unique identifier may be transmitted from the server to the browser device for storage on the browser device, where the second unique identifier is associated with the second user. Second user information associated with the second user is received at the server, from the browser device, and is stored in the memory of the server, and the second unique identifier is associated with the second user information, in the memory of the server.

According to a further aspect, a later connection is established with the browser device at the server. An indication of the unique identifier is received at the server, from the browser device, and then content is transmitted from the server to the browser device, such that the content is configured according to the user information.

Additional aspects of the present invention relate to a method for processing information, such as user preferences and other user information, which operates in connection with a browser device. A connection is established with a server, at the browser device. A unique identifier is received at the browser device, from the server, and the unique identifier is stored in a memory of the browser device. User information is transmitted from the browser device to the server for storage on the server, such that the unique identifier is associated with the user information in the server. The user information includes one or more of the types of information described above. Content is received from the server that is configured according to the user information, as well as configured according to analytic information derived from analysis of the existing user information. The content is displayed at a user interface associated with the browser device.

According to one aspect, the browser device is a mobile device, such as a mobile phone or smart phone, PDA, portable computer, portable gaming system, etc.

According to another aspect, the unique identifier and the user information are associated with a first user of the browser device. In this embodiment, the method may further include establishing a second connection with the server, at the browser device, involving a second user of the browser device. A second unique identifier is received at the browser device, from the server, and stored in the memory of the browser device. The second unique identifier is associated with the second user. Second user information associated with the second user is then transmitted from the browser device to the server for storage on the server, where the second unique identifier is associated with the second user information in the server.

According to a further aspect, the user information includes graphic display information, and wherein the content is displayed in a configuration dictated by the graphic display information.

According to yet another aspect, a later connection is established with the server at the browser device, an indication of the unique identifier is transmitted from the browser device to the server, and then content is received from the server, at the browser device. The content is configured according to the user information.

Further aspects of the present invention relate to a method for processing information, such as user preferences and other user information, which operates in connection with a server. An initial connection is established with a browser device, at the server, and a user ID is received from the browser device, the user ID being associated with the user of the browser device. A unique identifier is transmitted to the browser device for storage on the browser device, and the unique identifier is associated with the user ID, in a memory of the server. User information is then received from the browser device, stored in the memory of the server, and associated with a unique identifier in the memory of the server. The user information includes one or more of the types of information described above. A subsequent connection is established with the browser device, including receiving the user ID from the browser device, however the unique identifier is no longer accessible to the browser device. The user information is identified and/or accessed in the memory of the server, based on the user ID. Content is then transmitted from the server to the browser device, such that the content is configured according to the user information.

According to one aspect, the user information is identified in the memory of the server via association between the unique identifier and the user ID and association between the unique identifier and the user information.

According to another aspect, the method further includes transmitting a new unique identifier to the browser device for storage on the browser device. The new unique identifier is associated with the user ID, in the memory of the server, and the new unique identifier is also associated with the user information, in the memory of the server.

According to a further aspect, the new unique identifier is different from the original unique identifier in at least one characteristic.

Still further aspects of the invention relate to a system, including a server or a browser device, having components, such as a processor and a memory, configured for performing the methods described herein, and to a computer program product that is configured to cause a processor or other computer component to perform the methods described herein.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

To understand the present invention, it will now be described by way of example, with reference to the accompanying drawings in which:

FIG. 1 is a schematic diagram of one embodiment of a computer system;

FIG. 2 is a flow diagram of one embodiment of a method for storing and loading user preference information;

FIG. 2A is a flow diagram of another embodiment of a portion of the method of FIG. 2;

FIG. 3 is a schematic diagram of one embodiment of a system including a browser device and a server, shown in a process of storing information;

FIG. 4 is a schematic diagram of FIG. 3, shown in a process of loading information;

FIG. 5 is a schematic diagram of another embodiment of a system including a browser device and a server, shown in a process of storing information; and

FIG. 6 is a schematic diagram of another embodiment of a system including a server and a plurality of browser devices.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. The term “computer readable medium” as used herein includes not only a single medium or single type of medium, but also a combination of one or more media and/or types of media. Such a computer-readable medium may store computer-readable instructions (e.g., software) and/or computer-readable data (i.e., information that may or may not be executable). Any suitable computer readable media may be utilized, including various types of tangible computer readable storage media such as hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

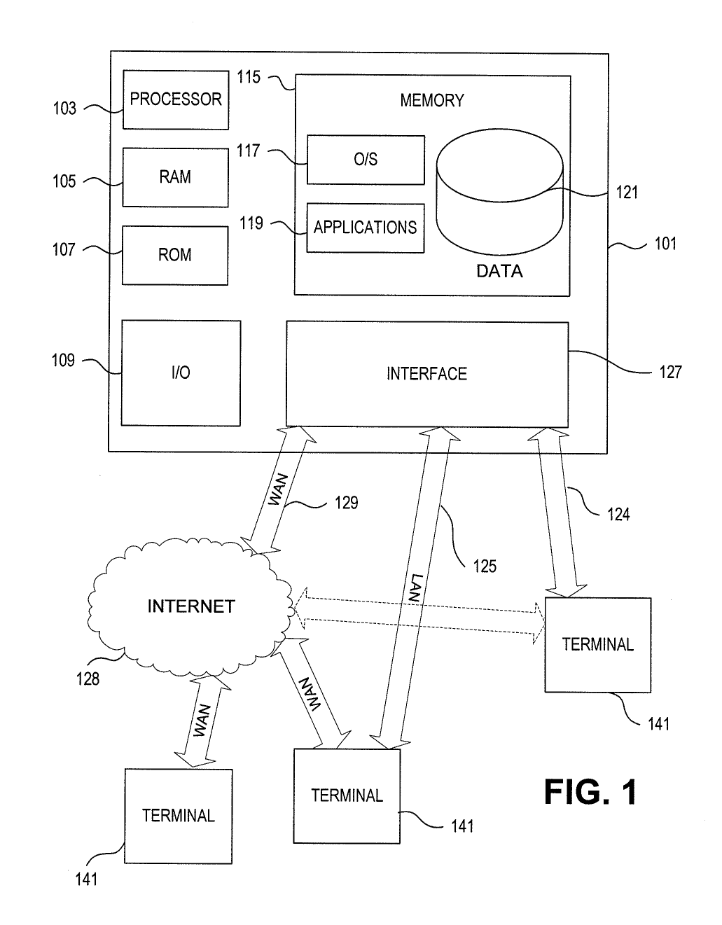

FIG. 1 illustrates a block diagram of a computer device or system 101 that may be used according to an illustrative embodiment of the invention. A “computer device” as referred to herein includes any electronic, electro-optical, and/or mechanical device, or system of physically separate such devices, that is able to process and manipulate information, such as in the form of data. Non-limiting examples of a computer device includes one or more personal computers (e.g., desktop or laptop), servers, personal digital assistants (PDAs), ultra mobile personal computers, smart phones, cellular telephones, pagers, and/or a system of these in any combination. In addition, a given computer device may be physically located completely in one location or may be distributed amongst a plurality of locations (i.e., may implement distributive computing). A computer device may even be a mobile device. As such, any of the computer components or devices described herein, such as servers, browser devices, etc., may be embodied generally as shown in the computer device 101 of FIG. 1.

As shown in FIG. 1, the computer device 101 may have a processor 103 for controlling overall operation of the computer device 101 and its associated components, including RAM 105, ROM 107, input/output module 109, and memory 115. I/O 109 may include a user input device through which a user of computer 101 may provide input, such as a microphone, keypad, touch screen, mouse, and/or stylus, and may also include one or more of a speaker for providing audio output and a video display device for providing textual, audiovisual and/or graphical output.

Software may be stored within memory 115 and/or storage to provide instructions to processor 103 for enabling the computer device 101 to perform various functions, including functions relating to the methods described herein. For example, memory 115 may store software used by the computer device 101, such as an operating system 117, application programs 119, and an associated database 121. Alternatively, some or all of the computer executable instructions may be embodied in hardware or firmware (not shown). It is understood that a computer device 101, single processor 103, and single memory 115 are shown and described for sake of simplicity, and that the computer system 101, processor 103, and memory 115 may include a plurality of computer systems, processors, and memories respectively.

The computer device 101 may be configured to operate in a networked environment supporting connections to one or more other computers, such as terminals 141. The terminals 141 may be personal computers or servers that include many or all of the elements described above relative to the computer 101. The network connections depicted in FIG. 1 include a wide area network (WAN) 129, but may also include other networks, such as a local area network (LAN) 125. When used in a LAN networking environment, the computer 101 is connected to the LAN 125 through a network interface or adapter 123. When used in a WAN networking environment, the computer 101 may include a modem 127 or other means for establishing communications over the WAN 129, such as the Internet 128. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer device 101 according to an illustrative embodiment of the invention may include computer executable instructions for invoking user functionality related to communication, such as email, short message service (SMS), and voice input and speech recognition applications.

In a general embodiment, a browser device forms a connection with a web server and stores a unique identifier received from the web server. The web server then stores user preferences or other user information received from the browsing device, and can apply, access, or otherwise utilize such user information on subsequent visits by recognition of the unique identifier. The user information may include any of a variety of user preferences, including: language preferences, graphic display configuration preferences, other display preferences, disability preferences, marketing preferences, and content preferences as well as other user information, including: personal user information (including login or other authentication information, identification information, contact information, or other types of personal information), browsing history (including pages visited and the last page visited), visitor type (registered or unregistered by the web server), customer status (i.e. whether the user is a customer of an entity operating the web server or the web page), user analytic information, and relationship information, including relationships between the user and one or more accounts and/or one or more other entities (such as if the user is a customer of the entity operating the web server). In one embodiment, the user preferences include at least content preferences and marketing preferences, and the user information also includes at least relationship information. User analytic information, mentioned above, may include information that is created by the operator of the web server or a third party, such as by analysis of other user information, rather than being obtained actively or passively from the user. The user analytic information may include, for example, information about likely user interests, which may be developed based on analysis of the user's browsing history, purchase history, or other information. It is understood that the user information that is stored on the web server and accessible using the unique identifier may include only non-confidential information.

In one embodiment, the web server may be operated by a financial institution, and the user analytic information may include information obtained through analysis of the user's financial positions, including account types, balances, investments, etc. The user information may be stored in different ways on the server. For example, the user information is stored in a database in one embodiment, or could alternately be stored in a spreadsheet, in a text file, in a cookie, or in any of various other data storage forms and methods in other embodiments.

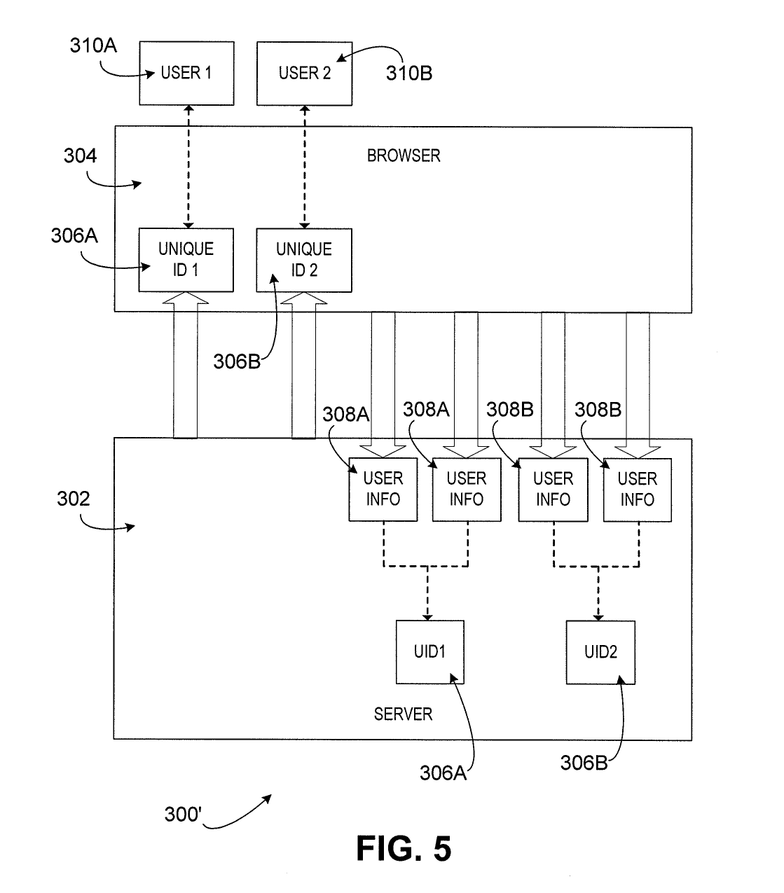

The unique identifier may be stored in or embodied by a cookie or similar element, which may include one or more name-value pairs or other text element. Such a cookie may be a persistent cookie, and may have an expiration date, after which the cookie will not be recognized by the server. The cookie embodying the unique identifier can be relatively easy to delete and/or replace if necessary. However, in other embodiments, the unique identifier may take a different form, and may be more difficult to delete and/or replace. Additionally, the unique identifier may be associated with a particular computer device, a particular browser supported by the computer device, and/or a particular user of the computer device. In one embodiment, the unique identifier is associated with a particular user, a particular browser, and a particular device, so that a single device may contain a plurality of unique identifiers associated with different users and/or browsers, as described below and illustrated in FIG. 5. In such an embodiment, the unique identifier transmitted by the browser may be governed by which particular user is logged into or otherwise authenticated or registered on the browser device. It is understood that, in this embodiment, the browser device may have one or more unique identifiers stored for other users, but the browser may not transmit a unique identifier to the server if the browser device does not have a unique identifier stored for the current user. In other embodiments, a particular device and/or browser may contain only a single unique identifier.

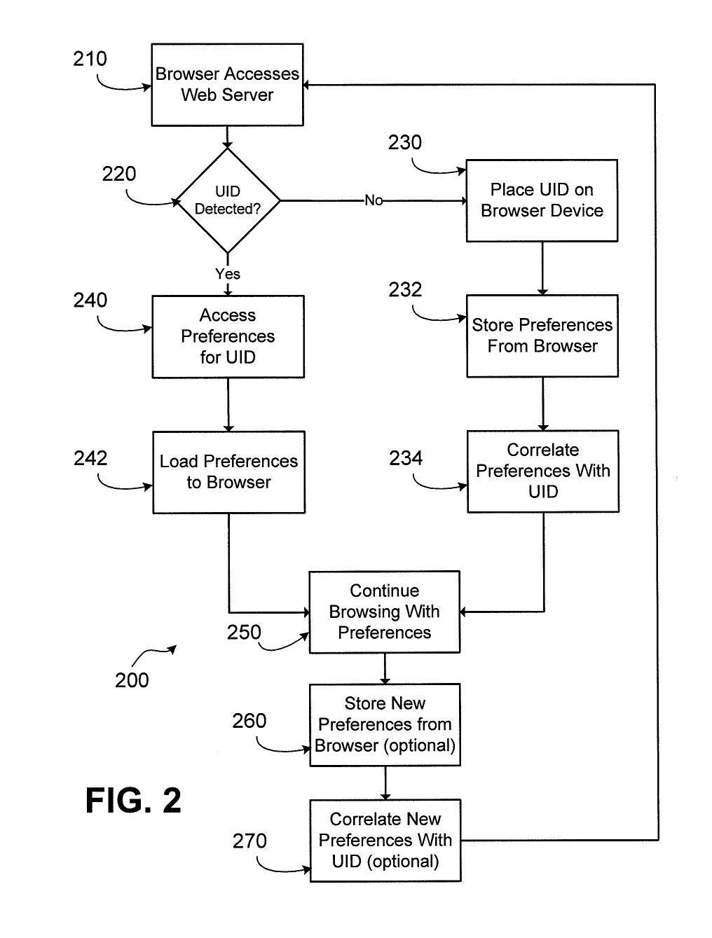

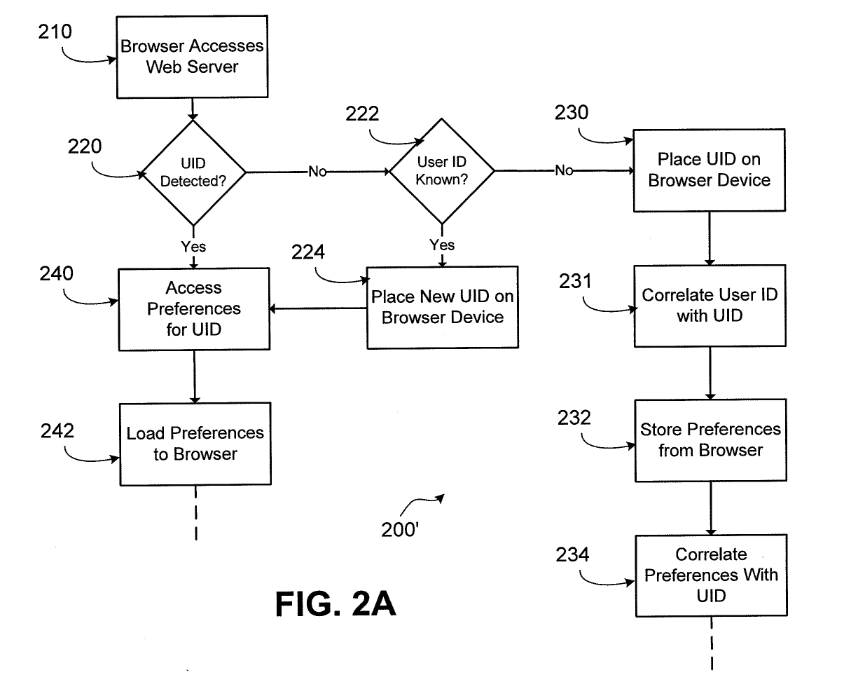

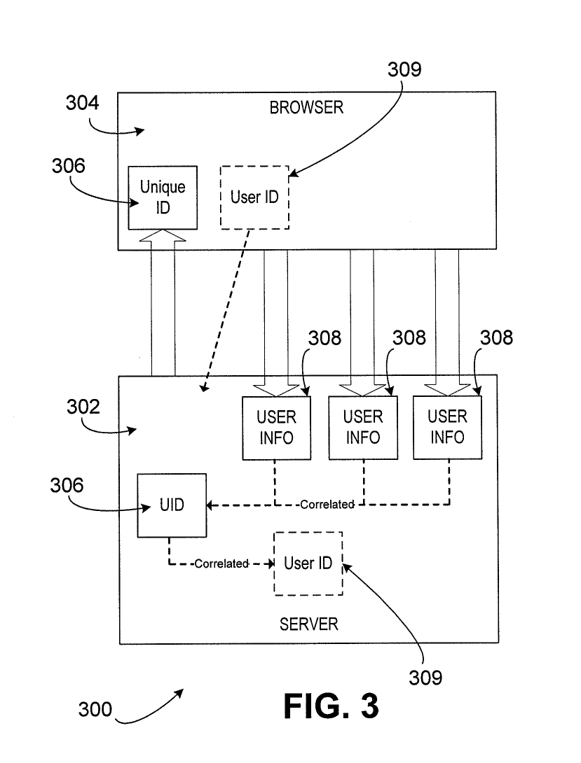

FIG. 2 illustrates one example embodiment of a method 200 for processing user information in the context of a connection between a server and a browser on a browser device. As stated above, the server and the browser device described in the context of this embodiment of the method 200 may be configured similarly to the computer device 101 of FIG. 1, and may include any or all components thereof. As used herein, a “browser device” means any computer device that is capable of a browsing function, such as by supporting a web browser application, including mobile and/or wireless devices such as cellular telephones, smart phones, PDA's, etc. Additionally, the embodiment of the method 200 shown in FIG. 2, or aspects thereof, can be used in connection with the systems 300, 300′, 400 illustrated in FIGS. 3-6 and described in greater detail below.

In the embodiment shown in FIG. 2, the method 200 begins with a browser supported by a browser device accessing a web server, at step 210. Accessing the web server can be accomplished as known in the art, such as through establishing a session between the browser device and the web server. In one embodiment, the accessing step does not require a login or other user authentication to the web server, however in another embodiment, login or other authentication may be required before proceeding. It is understood that login or other authentication to the browser device may be necessary in some circumstances. During or after the accessing step 210, the web server detects whether the browser is associated with a unique identifier recognized by the web server, at step 220. Typically, the browser will be associated with a unique identifier if the web server has previously placed a unique identifier on the browser, such as if/when the browser has accessed the web server in the past. In one embodiment, the browser transmits the unique identifier, if it exists, to the web server, and if the web server does not receive the unique identifier from the browser, the web server does not detect such a unique identifier. As described above, the unique identifier may be associated with a particular browser and/or a particular user, along with the browser device. Accordingly, the browser may not transmit, and the server may not detect, a unique identifier if the user and/or the browser are different from a previous user and/or browser that accessed the website using the browsing device. In another embodiment, the server may request the unique identifier from the browser. It is understood that the server may not detect the unique identifier for another reason, such as if the unique identifier is expired or corrupted.

If the web server does not detect (at step 220) a unique identifier associated with the browser device, the web server places a unique identifier on the browser device by transmitting the unique identifier to the browser for storage, at step 230. The browser stores the unique identifier in the memory of the browser device. The browser then transmits user preference information or other user information to the server, which information is stored on the server, at step 232. This information can be in any form recognizable to the server and storable on the server, including the forms described above. The user information is associated with the unique identifier in the memory of the server, at step 234. This association allows the user information to be recalled at a later time by associating the user information with the unique identifier, and thus using the unique identifier as a “key,” as described below. It is understood that steps 232-234 may be repeated in the course of the method 200.

If the web server does detect (at step 220) a unique identifier associated with the browser device, the web server accesses in memory the user information associated with the detected unique identifier, at step 240, and loads the user information to the browser, at step 242. The user information can be loaded to the browser (at step 242) in several different ways, and it is understood that the type or nature of the user information may favor a certain manner or manners of loading the information. For example, user information can be transmitted directly to the browser, where it may be accessed, displayed, etc., by the browser device, or may be used by the browser device in configuring other information for display or other use by the browser. As another example, the user information can be used to configure information prior to sending to the browser. For example, the user information can be used to configure content for display by the browser prior to sending the content. User preference information can be used to configure content either at the server, prior to sending the content to the browser, or at the browser, after receiving the content from the server. As used herein, “display” is not limited to a visual or graphical display on a graphical interface, but also includes other techniques and apparatuses for conveying information to a user, including but not limited to, audible or other sensory display, visual display by physical reproduction (such as printing), and other such techniques and apparatuses. It is understood that user preferences may relate to features other than displaying content, such as influencing the communication between the browser and the server, the functioning of the browser device or the server, or other such features. It is also understood that the user information loaded to the browser may include customized links to web pages that may interest the user. For example, in one embodiment, the web server may be operated or affiliated with a financial institution, and the user information may include analytic information developed from other user information, such as links to different accounts associated with the user or advertisements for financial products that may interest the user.

The user information may also be processed or otherwise utilized by the web server for other purposes and applications as well, upon recognition of the unique identifier at step 220. For example, the web server or an associated device may analyze or modify the user information during the session and transmit additional information to the browsing device. The user information may also be used to analyze user patterns and develop additional information in offline processes.

Whether the method 200 proceeds via steps 230-234 or steps 240-242, the browser device can then continue browsing and accessing the web server with the selected preferences (from step 232 or 242), at step 250. Additionally, the user can optionally create additional or different preferences or other user information, at step 260, which are transmitted to the server and stored by the server as described above with respect to step 232. These new preferences or other information are associated with the unique identifier in the memory of the server, as also described above, in step 270. It is understood that steps 250-270 may be repeated in the course of the method 200, which can permit repeated or continuous updating of the user information during the connection between the browser device and the server.

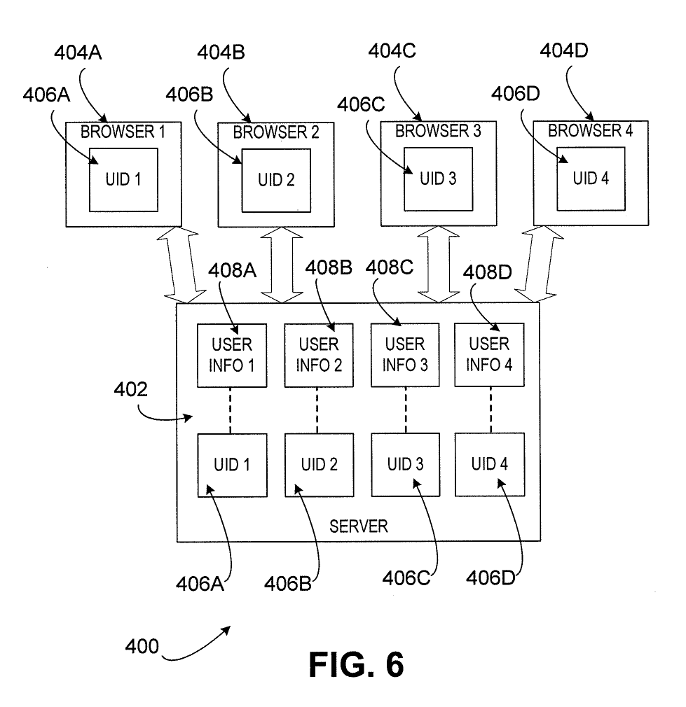

Once the connection between the browser and the web server ends (such as ending the session), the method 200 returns to step 210, such as if the browser accesses the web server at a later time. Accordingly, it is understood that the first time a user accesses the web server, the method 200 may progress through steps 210-220-230-232-234-250-260-270, because no unique identifier has been placed on the browser device for that user. Likewise, if a previously-placed unique identifier has expired, the method may progress in the same manner. In subsequent connections between the browser device and the server, the method 200 may progress through steps 210-220-240-242-250-260-270, because the previously-placed unique identifier can be detected by the server. It is understood that the method 200 can be repeated by the browser device and/or the server for subsequent connections involving different users, browsers, and/or browser devices, such as in the servers 302, 402 and browser devices 304, 404A-D described below and shown in FIGS. 5-6.

FIG. 2A illustrates an embodiment of a method 200′, representing an alternate embodiment of progressing through steps 210, 220, 230, 232, 234, 240, and 242 of the method 200 shown in FIG. 2 and described above. In the embodiment of FIG. 2A, the web server recognizes a user ID associated with the browser device (such as a login ID for the web server or the browser device), and may store and associate or correlate the user ID with the unique identifier for additional recognition. The user ID may be received from the browser device at any time, such as during the establishment of the connection between the browser device and the web server, at step 210. In this embodiment, if a unique identifier is not detected at step 220, the web server checks to see if the user ID associated with the browser device is known, or in other words, is associated with any unique identifier previously placed on a browser device, at step 222. If the user ID is not known, the method 200′ then proceeds to step 230, as in the method 200 of FIG. 2. Additionally, after step 230, the web server recognizes the user ID associated with the browser device and associates in memory the user ID with the unique identifier placed (at step 230) on the browser device, at step 231. The method 200′ then proceeds to step 232, as in the method 200 of FIG. 2.

If the user ID is known by the web server, by being associated with a previously-placed unique identifier in the memory of the web server, the web server places a new unique identifier on the browser device to replace the previously-placed unique identifier, at step 224. The new unique identifier is associated to the user information stored in the web server memory, in the same way as the previously-place unique identifier. It is understood that the new unique identifier may be identical to the previous unique identifier, or may be a different unique identifier, which may require further processing by the web server to associate the new unique identifier with the user information. The web server then identifies and accesses the user information based on the user ID, such as by association with the previous unique identifier associated with the known user ID, at step 240. In a further embodiment, the user information may also be associated with the user ID, and may be accessed by direct correlation with the user ID in the absence of the unique identifier. The method 200′ then proceeds to step 242, as in the method 200 of FIG. 2. It is understood that the remainder of the method 200′ may be identical to the remaining steps of the method 200 of FIG. 2, which are not shown in FIG. 2A.

The embodiment of the method 200′ illustrated in FIG. 2A can provide additional recognition of the user and/or browser device if the unique identifier is not available. For example, the unique identifier may be deleted by the browser device, lost due to damage to the browser device, expired, or otherwise no longer present on the browser device. In such a situation, the web server can still access and utilize the user information, and the previously gathered user information is not lost.

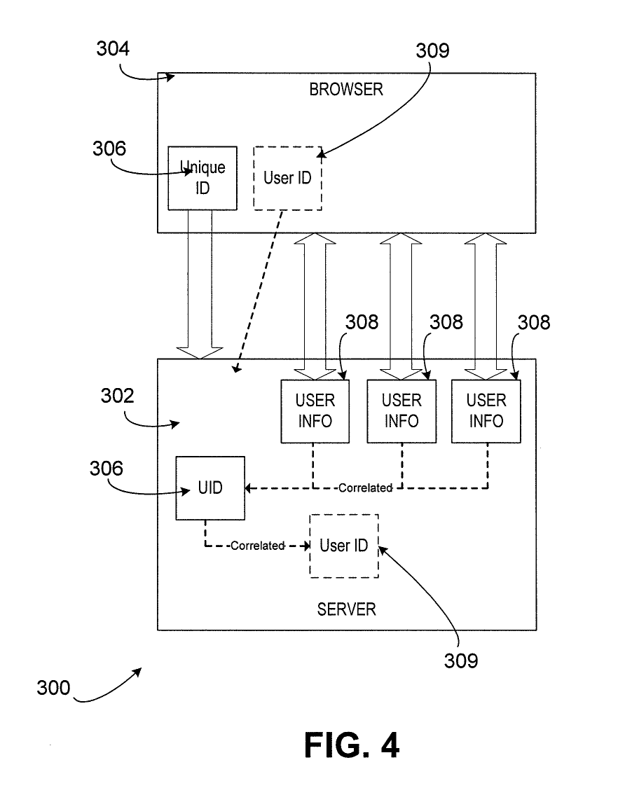

FIGS. 3-4 illustrate an example embodiment of a system 300 that includes a server 302 and a browser device 304. As stated above, the system 300 can be used in connection with at least some aspects of the method 200 in FIG. 2. FIG. 3 illustrates an embodiment of a server 302 and a browser device 304 in the process of storing information. As shown in FIG. 3, the server 302 transmits a unique identifier 306 to the browser device 304, which is stored in the memory of the browser device 304, such as in step 230 of the method 200. As also shown in FIG. 3, the browser 304 transmits user information 308 to the server 302, which is stored in the memory of the server 302, and the user information 308 is associated with the unique identifier 306 in the memory of the server 302. As also shown in FIG. 3, the browser device 304 optionally transmits a user ID 309 to the server 302, as discussed in the method 200′ of FIG. 2A. This user ID 309 may be associated with the unique identifier 306 in the memory of the server 302 as well.

FIG. 4 illustrates the state of the system 300 of FIG. 3 upon a subsequent access between the browser device 304 and the server 306. As shown in FIG. 4, the browser device 304 transmits the unique identifier 306 to the server 302, and the server 302 then communicates with the browser device 304 in accordance with the user information, as described above. The server 302 may also receive additional user information from the browser device 304, as described above with respect to steps 260-270 of FIG. 2, which is then associated with the unique identifier 306 as described above. The browser device 304 may also transmit the user ID associated with the user to the server 302. If the user ID of the browser device 304 is not available, the server 302 may associate the previously-stored unique identifier 306 to the user ID 309, as discussed in the method 200′ of FIG. 2A.

FIG. 5 illustrates another embodiment of the system 300′ of FIGS. 3-4 in a configuration where multiple users 310A-B utilize the browser device 304 to access the server 302. In this embodiment, the server 302 transmits a first unique identifier 306A associated with the first user 310A for storage on the browser device 304, when the first user 310A uses the browser device 304 to access the server 302. The server 302, in turn, receives at least some user information 308A related to the first user 310A from the browser device 304, which is stored in the memory of the server 302 and associated to the first unique identifier 306A. The server 302 also transmits a second unique identifier 306B associated with the second user 310B for storage on the browser device 304, when the second user 310B uses the browser device 304 to access the server 302. The server 302, in turn, receives at least some user information 308B related to the second user 310B from the browser device 304, which is stored in the memory of the server 302 and associated to the second unique identifier 306B. It is understood that the server 302 and the browser device 304 may operate as shown in FIG. 2 and described above. It is also understood that user ID's 309 corresponding to each user 310A-B may be transmitted from the browser device 304 to the server 302, and the server 302 may store and associate the previously-stored unique identifiers 306A-B to the user ID 309 for each user 310A-B, as discussed in the method 200′ of FIG. 2A and illustrated in FIGS. 3-4.

FIG. 6 illustrates an embodiment of a system 400 where a plurality of browser devices 404A-D are able to access a server 402 in a similar manner as shown and described above with respect to FIGS. 3-5. The plurality of browser devices 404A-D may include any number of devices, including any types of computer devices described herein. For example, in one embodiment, at least one of the browser devices 404A-D is a mobile device. In the embodiment shown in FIG. 6, the server 402 places a different unique identifier 406A-D on each browser device 404A-D. Additionally, the server 402 receives and stores user information 408A-D from each of the browser devices 404A-D, and each item of the user information 408A-D is associated with the unique identifier 406A-D associated with the respective browser device 404A-D from which the user information 408A-D was received. As described above, each of the unique identifiers 406A-D and the user information 408A-D may be associated with a particular browser device 404A-D, a particular browser, and/or a particular user. It is understood that any of the browser devices 404A-D may be used by more than one user, and may store multiple unique identifiers, as shown in FIG. 5 and described above. It is also understood that user ID's 309 corresponding to each user associated with one or more of the browser devices 404A-D may be transmitted from the browser device 404A-D to the server 402, and the server 402 may store and associate the previously-stored unique identifiers 406A-D to the user ID 309 for each user, as discussed in the method 200′ of FIG. 2A and illustrated in FIGS. 3-4. It is further understood that the server 402 and the browser devices 404A-D may operate as shown in FIG. 2 and described above.

As stated above, FIGS. 2-6 illustrate examples of one or more aspects of a system and method for processing user information, including user preferences. The steps of the methods described above can be accomplished by means and/or components contained within the computer system 101, such as the memory 115, processor 103, and/or program modules and computer-executable instructions stored therein or executed thereby, and may also be accomplished by non-computer means, such as by IT personnel or forensic investigators, or by a combination of human and computerized components. Other components of the computer system 101 may also constitute means for accomplishing aspects of the present invention, as understood by those skilled in the art. It is understood that one entity or computer system may not perform each and every aspect of the present invention and that aspects may be outsourced to one or more other entities.

Aspects of the present invention are operational with numerous other general purpose or special purpose computing system environments or configurations, such as the computer system 101 shown in FIG. 1. Examples of well known computing systems, environments, and/or configurations that may be suitable for use with the present invention include, but are not limited to, the various types of computer devices described above, including personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As also described above, aspects of the present invention may be described in the general context of computer-executable instructions, such as program modules, being executed by a computer. In one embodiment, at least some aspects of the present invention may be performed by a web browser application on a browser device. Generally, program modules include routines, programs, objects, components, data structures, etc. that perform particular tasks or implement particular abstract data types. The present invention may also be practiced in distributed computing environments where tasks are performed by remote processing devices that are linked through a communications network. In a distributed computing environment, program modules may be located in the memory 115, which may include both local and remote computer storage media including memory storage devices. It is understood that connections and communications disclosed herein may be made by any type of wired or wireless connection or communication.

Aspects of the present invention provide many benefits not provided by prior systems and methods for processing user information. For example, aspects of the invention provide for more efficient and effective management of user information, by allowing the browser device to only contain one unique identifier that acts as a “key” to the user information stored on the server. This reduces the number of cookies that need to be stored on the browser device. Additionally, limits on the number or size of cookies stored by a browser device need not limit the amount or nature of the user information that can be stored and retrieved. Thus, more information and a wider variety of information can be stored and automatically retrieved by the web server. These benefits may be particularly useful for mobile devices, which may have greater memory restrictions. Further, according to some aspects, only essential information is transmitted from the server to the browser device. This can help achieve bandwidth savings and processing time savings, as well as decreasing the information available to a malicious attacker who eavesdrops on the network transmission. Still other benefits and advantages exist and are apparent to those skilled in the art.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is further understood that the invention may be in other specific forms without departing from the spirit or central characteristics thereof. The present examples therefore are to be considered in all respects as illustrative and not restrictive, and the invention is not to be limited to the details given herein. The term “plurality,” as used herein, indicates any number greater than one, either disjunctively or conjunctively, as necessary, up to an infinite number. Accordingly, while the specific examples have been illustrated and described, numerous modifications come to mind without significantly departing from the spirit of the invention and the scope of protection is only limited by the scope of the accompanying claims.

What is claimed is:

1. A method comprising:
establishing a connection with a browser device, at a server;
transmitting, from the server, a unique identifier to the browser device for storage on the browser device;
receiving, at the server, user information from the browser device;
storing the user information in a memory of the server;
associating the unique identifier with the user information, in the memory of the server, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
storing additional user information in the memory of the server, comprising analytic information derived from analysis of the user information selected from the group; and
associating the unique identifier with the additional user information, in the memory of the server.

2. The method of claim 1, wherein the unique identifier is stored in a cookie.

3. The method of claim 1, wherein the unique identifier and the user information are associated with a first user of the browser device, further comprising:
establishing a second connection with the browser device, at the server, involving a second user of the browser device;
transmitting, from the server, a second unique identifier to the browser device for storage on the browser device, wherein the second unique identifier is associated with the second user;
receiving, at the server, second user information associated with the second user, from the browser device;
storing the second user information in the memory of the server; and
associating the second unique identifier with the second user information, in the memory of the server.

4. The method of claim 1, further comprising:
establishing a later connection with the browser device at the server;
receiving, at the server, an indication of the unique identifier from the browser device; and
transmitting content from the server to the browser device, wherein the content is configured according to the user information and the additional user information.

5. The method of claim 1, wherein analytic information is generated by analysis performed by the server.

6. A tangible computer-readable storage medium comprising computer-executable instructions configured to cause a processor of a server to perform:
establishing a connection with a browser device;
transmitting a unique identifier to the browser device for storage on the browser device;
receiving user information from the browser device;
storing the user information in a memory of the server;
associating the unique identifier with the user information, in the memory, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
storing additional user information in the memory of the server, comprising analytic information derived from analysis of the user information selected from the group and
associating the unique identifier with the additional user information, in the memory of the server.

7. The tangible computer-readable storage medium of claim 6, wherein the unique identifier and the user information are associated with a first user of the browser device, and wherein the computer-executable instructions are further configured to cause the processor to perform:
establishing a second connection with the browser device, involving a second user of the browser device;
transmitting a second unique identifier to the browser device for storage on the browser device, wherein the second unique identifier is associated with the second user;
receiving second user information associated with the second user, from the browser device;
storing the second user information in the memory; and
associating the second unique identifier with the second user information, in the memory.

8. The tangible computer-readable storage medium of claim 6, wherein the computer-executable instructions are further configured to cause the processor to perform:
establishing a later connection with the browser device;
receiving an indication of the unique identifier from the browser device; and
transmitting content to the browser device, wherein the content is configured according to the user information and the additional user information.

9. The tangible computer-readable storage medium of claim 6, wherein the computer-executable instructions are further configured to cause the processor to perform:
analyzing the user information to generate the additional user information.

10. A computer device comprising:
a memory configured for storing information; and
a processor in communication with the memory, the processor being configured to perform:
establishing a connection with a browser device;
transmitting a unique identifier to the browser device for storage on the browser device;
receiving user information from the browser device;
storing the user information in the memory;
associating the unique identifier with the user information, in the memory, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
storing additional user information in the memory, comprising analytic information derived from analysis of the user information selected from the group and
associating the unique identifier with the additional user information, in the memory.

11. The computer device of claim 10, wherein the unique identifier and the user information are associated with a first user of the browser device, and wherein the processor is further configured to perform:
establishing a second connection with the browser device, involving a second user of the browser device;
transmitting a second unique identifier to the browser device for storage on the browser device, wherein the second unique identifier is associated with the second user;
receiving second user information associated with the second user, from the browser device;
storing the second user information in the memory; and
associating the second unique identifier with the second user information, in the memory.

12. The computer device of claim 10, wherein the processor is further configured to perform:
establishing a later connection with the browser device;
receiving an indication of the unique identifier from the browser device; and
transmitting content to the browser device, wherein the content is configured according to the user information and the additional user information.

13. The computer device of claim 10, wherein the processor is further configured to perform:
analyzing the user information to generate the additional user information.

14. A method comprising:
establishing a connection with a server, at a browser device, using a browser application;
receiving, at the browser device, a unique identifier from the server;
storing the unique identifier in a memory of the browser device; and
transmitting user information from the browser device to the server for storage on the server, wherein the unique identifier is associated with the user information in the server, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
receiving, at the browser device, content from the server that is configured according to the user information and is further configured according to analytic information derived from analysis of the user information; and
displaying the content at a user interface associated with the browser device.

15. The method of claim 14, wherein the browser device is a mobile device.

16. The method of claim 14, wherein the user information comprises graphic display information, and wherein the content is displayed in a configuration dictated by the graphic display information.

17. The method of claim 14, wherein the unique identifier and the user information are associated with a first user of the browser device, further comprising:
establishing a second connection with the server, at the browser device, involving a second user of the browser device;
receiving, at the browser device, a second unique identifier from the server, wherein the second unique identifier is associated with the second user;
storing the second unique identifier in the memory of the browser device; and
transmitting second user information associated with the second user from the browser device to the server for storage on the server, wherein the second unique identifier is associated with the second user information in the server.

18. The method of claim 14, further comprising:
establishing a later connection with the server at the browser device;
transmitting an indication of the unique identifier from the browser device to the server; and
receiving content from the server, at the browser device, wherein the content is configured according to the user information.

19. A method comprising:
establishing an initial connection with a browser device, at a server, including receiving a user ID from the browser device, the user ID being associated with a user of the browser device;
transmitting, from the server, a unique identifier to the browser device for storage on the browser device;
associating the unique identifier with the user ID, in a memory of the server,
receiving, at the server, user information from the browser device, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
storing the user information in the memory of the server;
associating the unique identifier with the user information, in the memory of the server;
establishing a subsequent connection with the browser device, at the server, including receiving the user ID from the browser device, wherein the unique identifier is no longer accessible to the browser device;
identifying the user information in the memory of the server, based on the user ID; and
transmitting content from the server to the browser device, wherein the content is configured according to the user information.

20. The method of claim 19, wherein the user information is identified in the memory of the server via association between the unique identifier and the user ID and association between the unique identifier and the user information.

21. The method of claim 19, further comprising:
transmitting, from the server, a new unique identifier to the browser device for storage on the browser device;
associating the new unique identifier with the user ID, in the memory of the server; and
associating the new unique identifier with the user information, in the memory of the server.

22. The method of claim 21, wherein the new unique identifier is different from the unique identifier.

23. A tangible computer-readable storage medium comprising computer-executable instructions configured to cause a processor of a server to perform:
establishing an initial connection with a browser device, including receiving a user ID from the browser device, the user ID being associated with a user of the browser device;
transmitting a unique identifier to the browser device for storage on the browser device;
associating the unique identifier with the user ID, in a memory of the server,
receiving user information from the browser device, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
storing the user information in the memory of the server;
associating the unique identifier with the user information, in the memory of the server;
establishing a subsequent connection with the browser device including receiving the user ID from the browser device, wherein the unique identifier is no longer accessible to the browser device;
identifying the user information in the memory of the server, based on the user ID; and
transmitting content to the browser device, wherein the content is configured according to the user information.

24. The tangible computer-readable storage medium of claim 23, wherein the user information is identified in the memory of the server via association between the unique identifier and the user ID and association between the unique identifier and the user information.

25. The tangible computer-readable storage medium of claim 23, wherein the computer-executable instructions are further configured to cause the processor to perform
transmitting a new unique identifier to the browser device for storage on the browser device;
associating the new unique identifier with the user ID, in the memory of the server; and
associating the new unique identifier with the user information, in the memory of the server.

26. A computer device comprising:
a memory configured for storing information; and
a processor in communication with the memory, the processor being configured to perform:
establishing an initial connection with a browser device, including receiving a user ID from the browser device, the user ID being associated with a user of the browser device;
transmitting a unique identifier to the browser device for storage on the browser device;
associating the unique identifier with the user ID, in the memory,
receiving user information from the browser device, wherein the user information comprises information selected from a group consisting of: language preferences, graphic display configuration preferences, other display preferences, disability preferences, marketing preferences, content preferences, personal user information, browsing history information, visitor type information, customer status information, relationship information, and user analytic information;
storing the user information in the memory;
associating the unique identifier with the user information, in the memory;
establishing a subsequent connection with the browser device including receiving the user ID from the browser device, wherein the unique identifier is no longer accessible to the browser device;
identifying the user information in the memory, based on the user ID; and
transmitting content to the browser device, wherein the content is configured according to the user information.

27. The computer device of claim 26, wherein the user information is identified in the memory of the server via association between the unique identifier and the user ID and association between the unique identifier and the user information.

28. The computer device of claim 26, wherein the processor is further configured to perform
transmitting a new unique identifier to the browser device for storage on the browser device;
associating the new unique identifier with the user ID, in the memory of the server; and
associating the new unique identifier with the user information, in the memory of the server.
